(19) United States
(12) Patent Application Publication
(10) Pub. No.: US 2019/0351466 A1
(43) Pub. Date: Nov. 21, 2019

(54) LABORATORY FUME HOOD HAVING GUIDED WALL JETS

(71) Applicant: Waldner Laboreinrichtungen GmbH & Co., KG, Wangen im Allgäu (DE)

(72) Inventors: Bernhard Bobusch, Berlin (DE); Oliver Krüger, Berlin (DE); Jürgen Liebsch, Scheidegg (DE); Christian Oliver Paschereit, Berlin (DE); Jens Hermann Wintering, Berlin (DE)

(21) Appl. No.: 16/474,247

(22) PCT Filed: Dec. 28, 2017
(86) PCT No.: PCT/EP2017/084706

§ 371 Date: Jun. 27, 2019

(30) Foreign Application Priority Data
Dec. 29, 2016 (DE) 10 2016 125 891.1

(51) Int. Cl. B08B 15/02; B01L 1/02

(52) U.S. Cl. CPC B08B 15/023; B01L 1/04; B01L 1/02

(57) ABSTRACT

The present invention relates to a fume cupboard 1 available for a laboratory space, which has a housing 60, in which a work space is located, which is limited on its front side by a front sash 30, on its base by a base plate 34 and by a side wall 36 on each of its sides. Furthermore, the fume cupboard comprises a first hollow profile 10, 10′ arranged on a front side of each side wall 36, wherein each hollow profile 10, 10′ has a first pressure chamber 10b, 10b′, which is fluidically connected to a plurality of first openings 10d, 10d′, out of which air jet streams in the form of wall jet streams 100 consisting of pressurised air can be emitted along the respective side wall 36 into the work space. The fume cupboard is characterized in that at least one of the first openings 10d, 10d′ is fluidically connected to the first pressure chamber 10b, 10b′ via a first longitudinal duct 10c, 10c′, and that the first duct 10c, 10c′ has a length L in the direction of flow that is at least three times the hydraulic diameter of a cross-sectional surface of the first opening 10d, 10d′, from the perspective perpendicular to the direction of flow in order to prevent flow displacement of the wall jet stream 100 coming out of the first opening 10d, 10d′ of the side wall 36 in an area of the front side of the work space up to at least 25% of the depth of the work space. Furthermore, the present invention relates to a fume cupboard, where such a hollow profile 20, 20′ is arranged on a front side of the base plate 34.

The present invention relates to a fume cupboard, in particular, to a flow-optimised and energy-efficient fume cupboard.

Energy saving is not only environmentally friendly, but reduces the sometimes very high operating costs in a modern laboratory space where, under certain circumstances, dozens of fume cupboards can be installed, each operating over 24 hours per day, seven days a week. However, the most important feature of modern fume cupboards is that they enable the safe handling of toxic substances and prevent the release of these substances from the work space of the fume cupboard. The extent of this safety is also referred to using the term retention capacity. For this purpose, a detailed series of standards “EN14175 Part 1 through Part 7” has been published, in which the influence of dynamic air flows on retention capacity is described, among other things. Many developments in the field of fume cupboards therefore relate to the question of how the energy consumption of such fume cupboards can be reduced without adversely affecting retention capacity.

Already in the 1950s, attempts were made to improve the outbreak safety of fume cupboards by means of an air curtain. This air curtain is created by means of air outlet nozzles provided on the side walls of the work space of the fume cupboard in the area of the front sash opening and should prevent the escape of any toxic fumes from the work space (U.S. Pat. No. 2,702,505 A).

In EP 0 486 971 A1, it was proposed to provide so-called airfoils at the front edge of the side columns and the front edge of the worktop, the contour of which is flow-optimised. Due to these airfoils, according to the doctrine of EP 0 486 971 A1, this should result in less displacement of the incoming ambient air at the air-flow surface of the airfoils when the front sash is open, thereby resulting in less air turbulence. However, behind these airfoils, there is an area, in which turbulence can result since the incoming ambient air can be displaced at the end downstream from the airfoils. This effect occurs intensively if ambient air enters into the fume cupboard at an angle to the side walls.

In GB 2 336 667 A, the retention capacity was further improved by providing airfoil-shaped profiles at a distance to the front edge of the worktop and the side posts so that ambient air cannot only enter into the interior space of the fume cupboard along the airfoil-shaped profiles, but also via the gap, which is mostly funnel-shaped and located between the profiles and the front edge of worktop on the one hand, and located between the side posts on the other. The ambient air is accelerated in the funnel-shaped gap so that the speed profile of the exhaust air in the area of the side walls and the worktop is increased.

Another milestone to increase the outbreak safety and reduce the energy demand of a fume cupboard at the same time was achieved by adding so-called support jet streams in an optimised manner. By means of providing hollow profiles both on the front edge of the worktop as well as on the front side of the side posts, pressurised air could be supplied into the hollow space of these profiles and blown into the work space through opening provided on the hollow profiles in the form of pressurised-air jet streams. The advantage of this is that the support jet streams along the side walls and along the worktop enter into the work space of the fume cupboard, meaning along the areas that are critical with regard to the risk of turbulence (backflow areas) and could therefore negatively affect retention capacity. The effect of the pressurised-air jet streams in the area of the side walls and the base of the work space is varied. They not only prevent flow displacement of the incoming ambient air on the downstream end of the hollow profiles, but also reduce any wall friction effects so that this can result in considerably less turbulence in these areas, therefore resulting in less backflow areas. The ambient air entering into the work space “slides”, so to say, on a dynamic pillow mowing toward the back along the wall and the worktop into the back area of the work space, where it is aspirated. At first glance, this seems contradictory, because supplying pressurised-air jet streams costs additional power. However, this positively affects the overall energy balance of the fume cupboard, since, in the other areas of the interior space of the fume cupboard, the air speed can be reduced without adversely affecting retention capacity. The minimum exhaust volume, which still fulfils the standardised regulations for outbreak safety of the fume cupboard, could be considerably reduced due to the support jet streams when the front sash is partially or completely open. An example of a fume cupboard that is equipped with support jet-stream technology is described in DE 101 46 000 A1, EP 1 444 057 B1 and U.S. Pat. No. 9,266,154 B2.

For the first time, in the case of fume cupboards equipped with conventional support jet-stream technology, the inventors of the present invention were able to observe that, in contrast to experiments performed beforehand with mist, where no significant flow displacement of the wall jet streams could be detected, during the examination of the flow field of the wall jet streams using PIV measurements (“Particle Image Velocimetry” measurements), a current displacement took place already at a relatively short distance behind the front sash level, subsequently resulting in dangerous backflow areas being able to form at the side walls.

The main objective of the present invention is therefore primarily to further improve outbreak safety of a fume cupboard equipped with support jet-stream technology and further reduce its power consumption at the same time.

This task is solved by means of the features of Patent Claims 1 and 2. Optional or preferred features of the invention are indicated in the independent patent claims.

In this way, on the one hand, the invention makes a fume cupboard available for a laboratory space, which has a housing, in which a work space is located, which is limited on its front side by a front sash, on its base by a base plate and by a side wall on each of its sides. Furthermore, the fume cupboard comprises a first hollow profile arranged on a front side of each side wall, wherein each hollow profile has a first pressure chamber, which is fluidically connected to a plurality of first openings, out of which air jet streams in the form of wall jet streams consisting of pressurised air can be emitted along the respective side wall into the work space. The fume cupboard is characterized in that at least one of the first openings is fluidically connected to the first pressure chamber via a first longitudinal duct, and that the first duct has a length L in the direction of flow that is at least three times the hydraulic diameter of a cross-sectional surface of the first opening, from the perspective perpendicular to the direction of flow, in order to prevent flow displacement of the wall jet stream coming out of the first opening of the side wall in an area of the front side of the work space up to at least 25% of the depth of the work space.

On the other hand, the invention makes a fume cupboard available for a laboratory space, which has a housing, in which a work space is located, which is limited on its front side by a front sash, on its base by a base plate and by a side wall on each of its sides. Furthermore, the fume cupboard comprises a second hollow profile arranged on a front side of the base plate, wherein the second hollow profile has a second pressure chamber, which is fluidically connected to a plurality of second openings, out of which air jet streams in the form of base jet streams consisting of pressurised air can be emitted along the base plate into the work space. The fume cupboard is characterized in that at least one of the second openings is fluidically connected to the second pressure chamber via a second longitudinal duct, and that the second duct has a length L in the direction of flow that is at least three times the hydraulic diameter of a cross-sectional surface of the second opening, from the perspective perpendicular to the direction of flow, in order to prevent flow displacement of the base jet stream coming out of the first opening of the base plate in an area of the front side of the work space up to at least 25% of the depth of the work space.

It is advantageous if the fume cupboard has both a first hollow profile as well as a second hollow profile.

According to a preferred embodiment of the invention, the first and/or the second duct has a length L in the direction of flow, which is at a range of four times to eleven times the hydraulic diameter of the cross-sectional area of the first and/or the second opening.

Preferably, no flow displacement of the wall jet stream coming out of the first opening from the side wall and/or of the base jet stream coming out of the second opening from the base plate occurs in an area of the front side of the work space up to at least 50% of the depth of the work space.

Even more preferably, no flow displacement of the wall jet stream coming out of the first opening from the side wall and/or of the base jet stream coming out of the second opening from the base plate occurs in an area of the front side of the work space up to at least 75% of the depth of the work space.

An advantageous embodiment of the invention is available if a first and/or a second pressure transducer is/are provided, which is/are fluidically connected to the first and/or the second pressure chamber.

Being further advantageous, the first and/or the second pressure transducer comprises a first and/or a second pressure transducer line, which is/are arranged in such a way that a pressure-chamber end of the first and/or second pressure transducer line ends in being flush with an inner surface of the first and/or the second pressure chamber.

Preferably, a control device is provided adjusts the pressure in the first and/or the second pressure chamber at a range from 50 Pa 500 Pa during intended use of the fume cupboard, preferably at a range from 150 Pa to 200 Pa.

Even more preferably, the control device is electrically connected to the first and/or the second pressure transducer.

According to a further preferred embodiment of the invention, the control device is a pressure reducer or a mass flow controller, that is arranged upstream to the first and/or the second pressure chamber.

Furthermore, the pressure reducer or the mass flow controller is preferably arranged within the housing.

It is advantageous if a cross-sectional surface of at least a first and/or a second opening, viewed perpendicularly to the direction of flow, preferably of all first and/or second openings, is at a range of 1 mm² to 4 mm².

It is even more advantageous if a cross-sectional surface, viewed perpendicular to the direction of flow, of at least of a first and/or a second opening, preferably all first and/or second openings, is at a range of 1.8 mm² to 3 mm².

A further advantageous embodiment of the invention is available if at least a first or a second opening, preferably all first or second openings are/is designed in such a way that the pressurised-air jet stream coming out of the first and/or the second opening is emitted into the work space as a periodically oscillating wall jet stream and/or as a periodically oscillating base jet stream.

Preferably, the periodicity is at a range of 1 Hz to 100 KHz, preferably at a range of 200 Hz to 300 Hz.

Being even more preferred, the periodic oscillation of the wall jet stream and/or the periodic oscillation of the base jet stream is generated by merely non-moving components of the first and/or the second hollow profile, which are preferably designed as a single piece.

Furthermore, it is advantageous if the periodic oscillation of the wall jet stream and/or the periodic oscillation of the base jet stream is/are generated by auto-stimulation.

According to another preferred embodiment of the invention, at least a first and/or a second fluidic oscillator is/are provided, which comprises/comprise the first and/or the second opening, preferably a plurality of first and second fluidic oscillators are provided, which comprise a first and/or a second opening respectively and, which generates/generate the periodic oscillation of the wall jet stream/wall jet streams and/or the periodic oscillation of the base jet stream/base jet streams.

Preferably, the first and/or the second openings have a circular, round, oval, rectangular or polygonal shape.

The invention shall now be described using the enclosed figures merely as an example. The figures show:

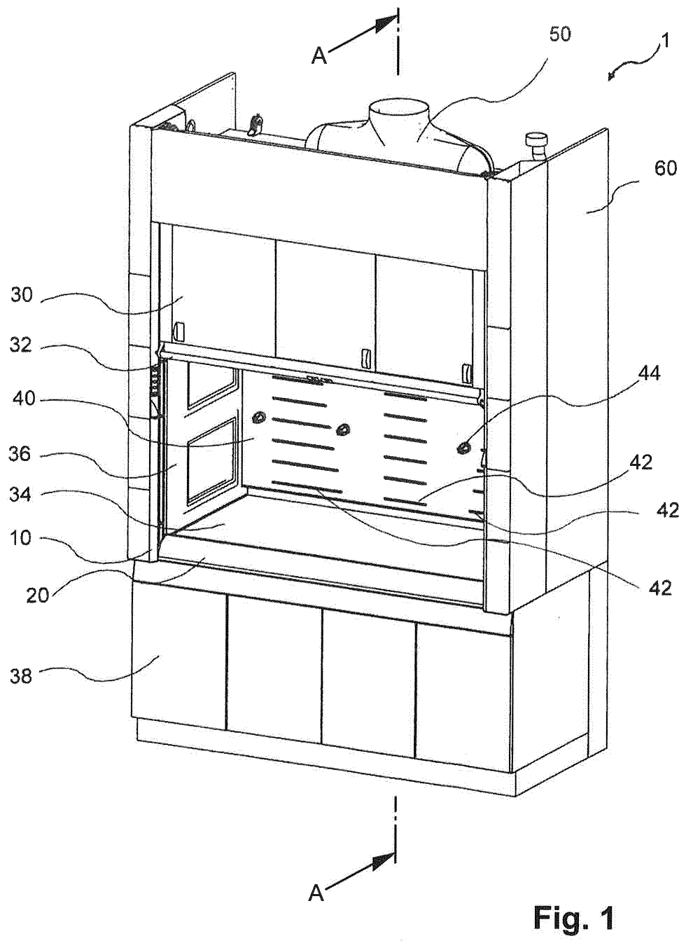

FIG. 1 a perspective view of a conventional fume cupboard;

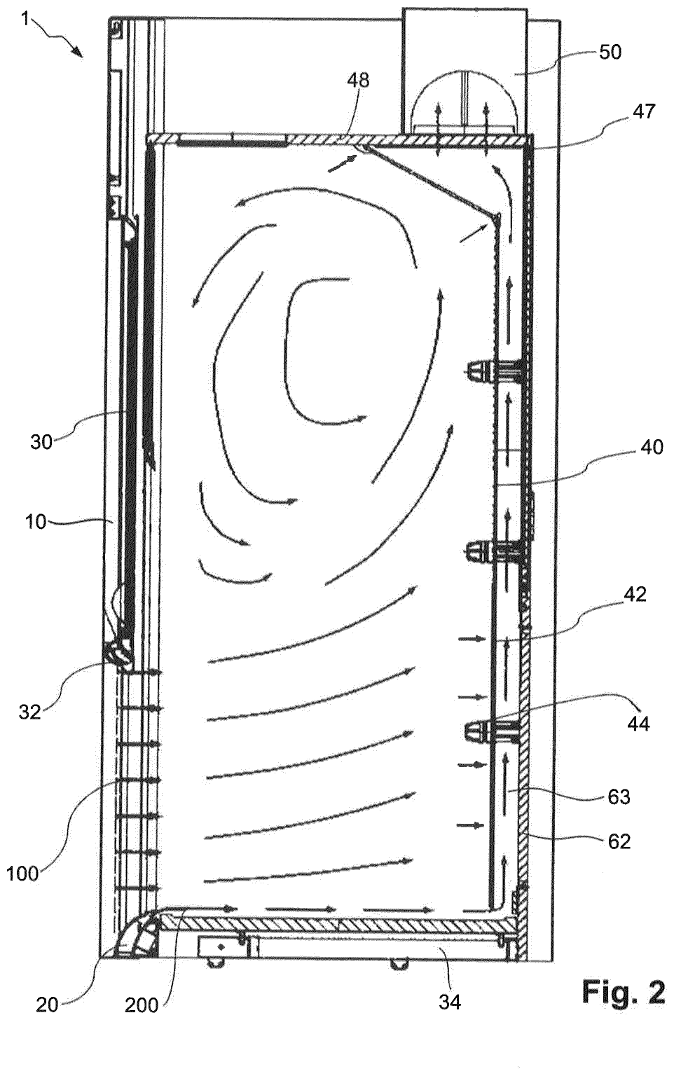

FIG. 2 a cross-sectional view of the fume cupboard shown in FIG. 1 along Line A-A shown in FIG. 1;

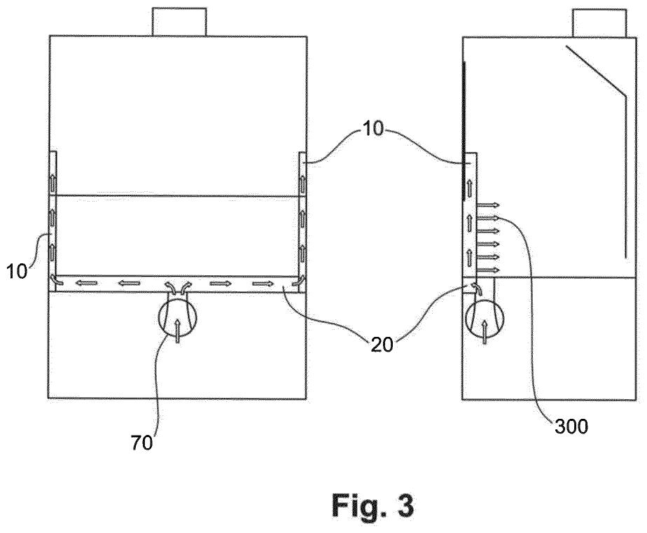

FIG. 3 the supply of pressurised air into the side post profiles and the base-plate profile;

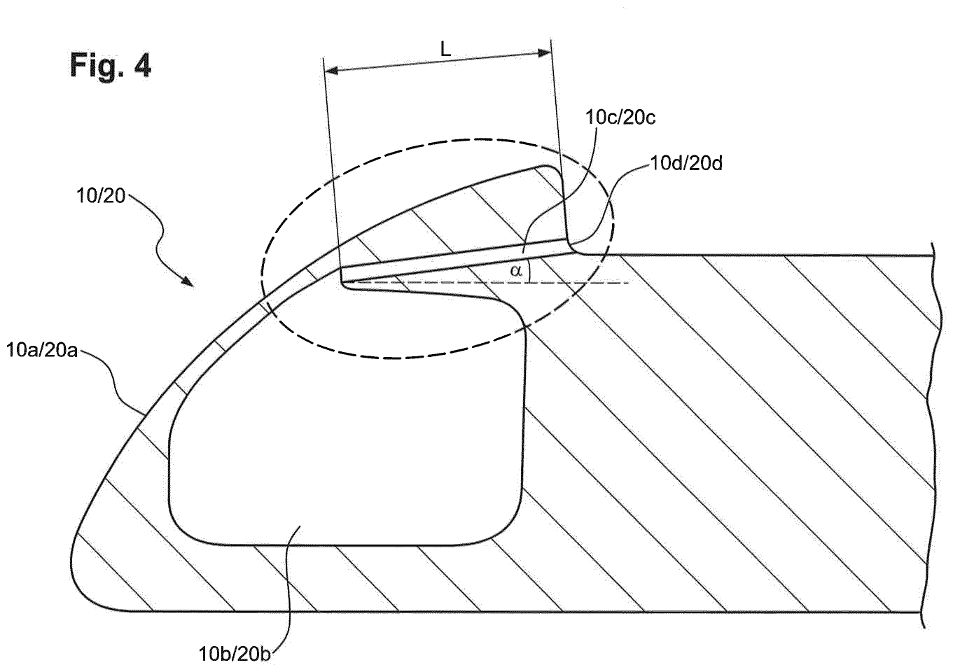

FIG. 4 a cross-sectional view of a hollow profile according to the invention that is arranged on the front side of the sidewall and/or of the front side of the base plate;

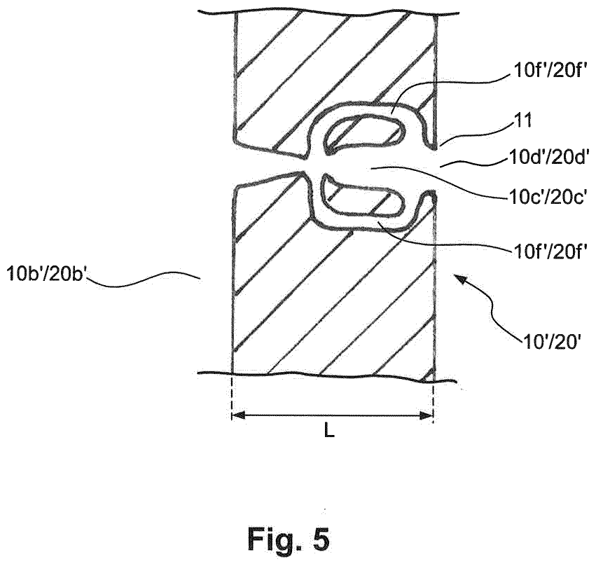

FIG. 5 A fluidic oscillator and the outlet duct of a hollow profile;

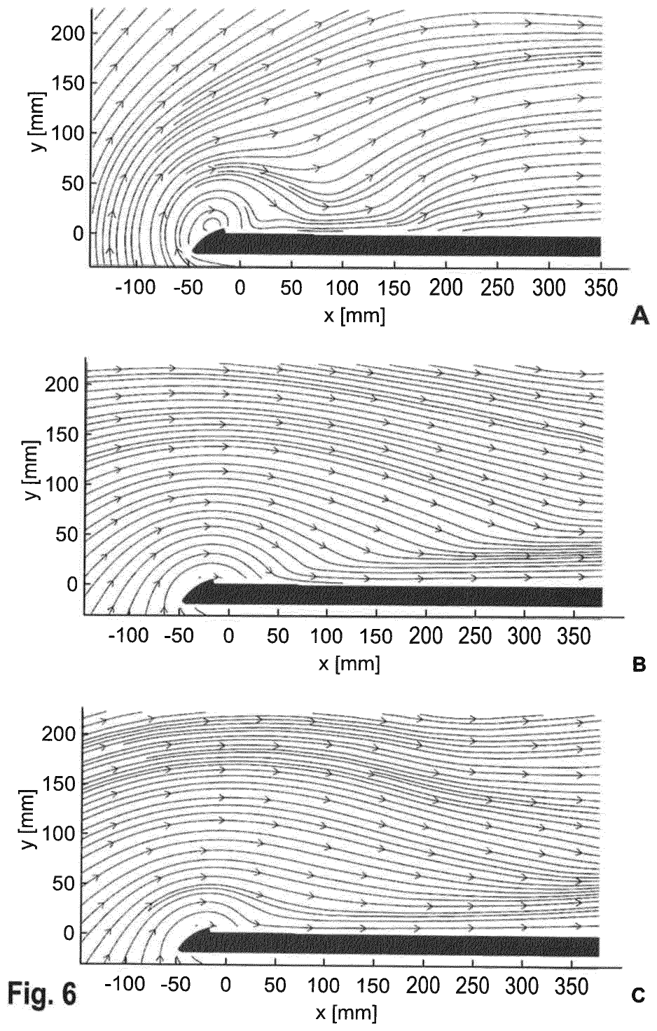

FIG. 6 the results of PIV measurements of the flow field of the wall jet streams in a conventional fume cupboard (FIG. 6A), in a fume cupboard with Jet nozzles according to a preferred embodiment of the invention (FIG. 6B) and in a fume cupboard with OsciJet nozzles according to another preferred embodiment of the invention (FIG. 6C);

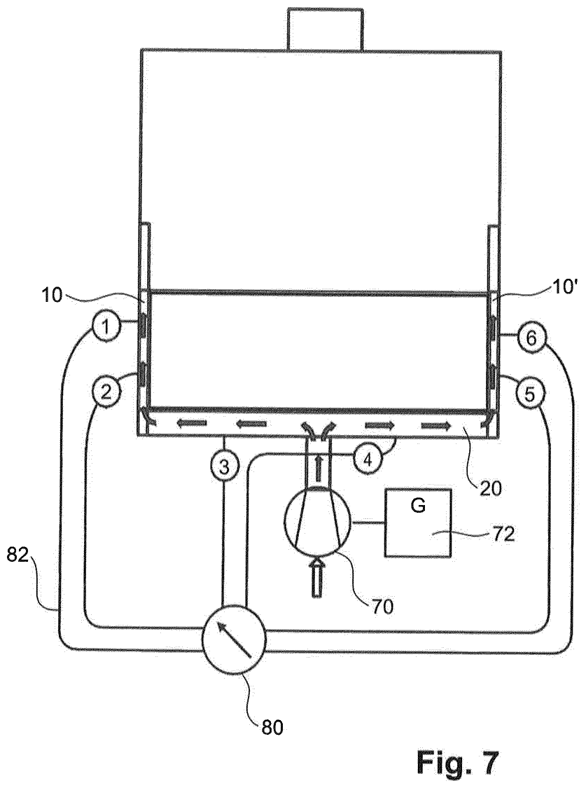

FIG. 7 a test set-up to determine this static air pressure in the pressure chambers of both side post profiles and the base profile;

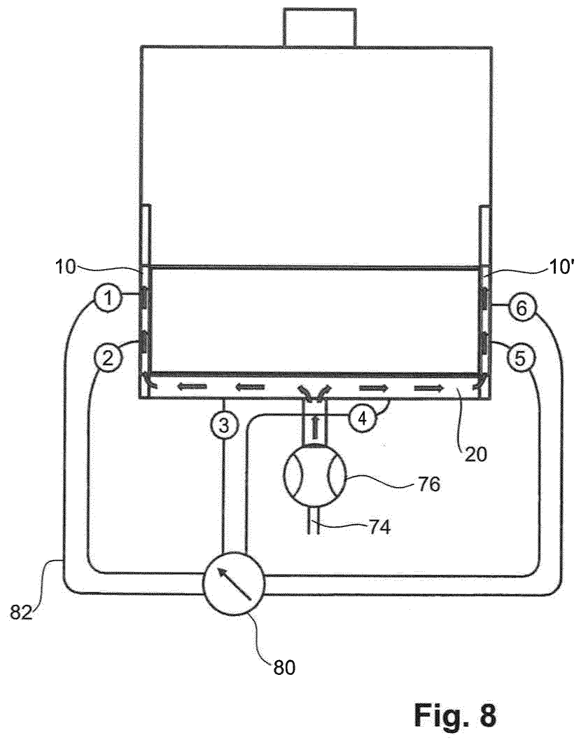

FIG. 8 a test set-up to determine the volume flow of the wall jet streams flowing out of the side post profiles;

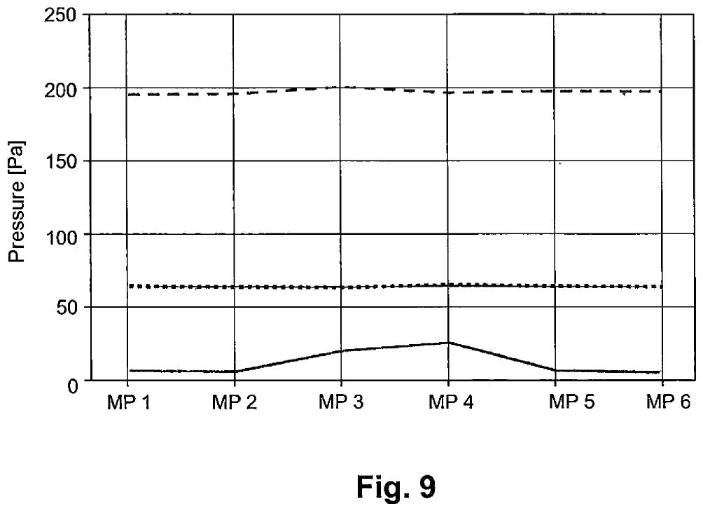

FIG. 9 the measurement results of the static pressure in the pressure chambers of the side post profiles of a conventional fume cupboard (solid line), of a fume cupboard with Jet nozzles and OsciJet nozzles at various control voltages of the fan (dotted and dashed line); and

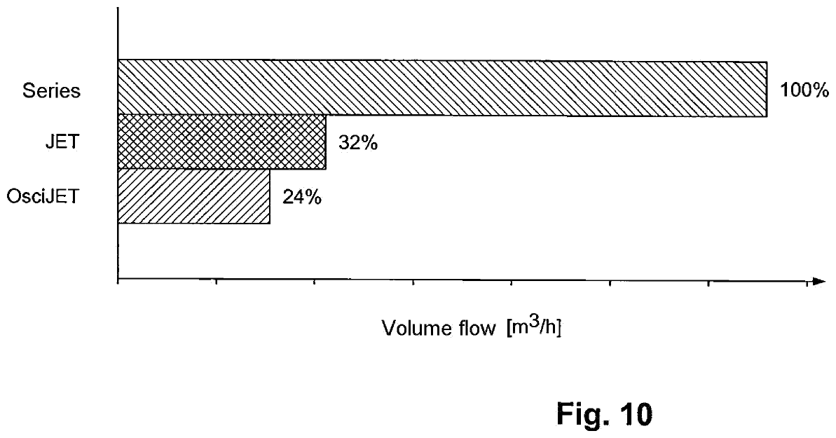

FIG. 10 a diagram, which shows the reduction of the volume flows of the wall jet streams for various nozzle geometries of the side post profiles.

The fume cupboard 1 prospectively shown in FIG. 1 approximately corresponds to the fume cupboard that has been marketed by the applicant since 2002 at almost a world-wide level under the name Secuflow®. Thanks to the support jet-stream technology described in the above, the fume cupboard requires an exhaust volume flow of only 270 m³/(h·lfm). This fume cupboard (name: Secuflow® TA-1500) serves as a reference for the measurements carried out within the scope of the present invention, which will be described further below.

The fume cupboard according to the invention corresponds to the fume cupboard 1 illustrated in FIG. 1 with regard to its basic construction. The fume cupboard according to the invention, in particular, deviates from the conventional Secuflow® fume cupboard with regard to the nozzle geometry of the hollow profiles 10, 20 and the way the pressurised air jet streams 100, 200 are emitted from the hollow profiles 10, 20.

The fume cupboard 1 shown in FIG. 1 has a fume cupboard inner space, which is limited on the backside, preferably by a deflecting wall 40, on the side by two sidewalls 36, on its base by a base plate 34 and worktop, on the front by a lockable front side—30 and on its topside preferably by a top panel 48.

The front/30 is preferably designed to be made of several parts in such a way that a plurality of vertically slidable window elements successively run concordantly in a telescope like manner one after another when opening and closing the front sash 30. The window element arranged the furthest-most down in the closed position of the front sash 30 preferably has an aerodynamically optimised airfoil 32 (FIG. 2) on its front edge. Furthermore the front sash 30 preferably has horizontally slidable window elements, which allow the laboratory personnel to access the inner space of the fume cupboard in the closed position of the front sash 30.

At this point, it is pointed out that the front sash 30 can also be designed as a two-piece sliding window, both parts of which can be inversely moved in a vertical direction. In this case, the inverse parts are coupled with the weights compensating the mass of the front sash via cords or straps and guide rollers.

Preferably, between the deflecting wall 40 and the back wall 62 (FIG. 2) of the fume cupboard housing 60, there is a duct 63 that leads to an exhaust-air collection duct 50 on the upper side of the fume cupboard 1. The exhaust-air collection duct 50 is connected to an exhaust device installed in the building.

There is a piece of furniture 38 arranged under the worktop 34 of the interior space of the fume cupboard, which serves as a storage space for various laboratory utensils. This piece of furniture is to be understood as a part of the housing 60 of the fume cupboard 100 in terms of the terminology used here.

Hollow profiles 10 are provided on the front side of the side wall 36 of the fume cupboard 1, which are conventionally also referred to as a side posts. A hollow profile 20 is also provided on the front side of the base plate 34.

When “on the front side” is referred to, this term is not to be understood literally. Thereby rather, constructions are intended which are simply provided or attached within the area of the front side.

The airfoil-shaped flow side 10a of the hollow profile 10 or the side post profile 10 (FIG. 4) is preferably also designed in an aerodynamically optimised manner, similar to the aerodynamically optimised airfoil 32 on the underside of the lowest front sash element 30. The same preferably also applies to the hollow profile 20 on the front side of the base plate 34. The airfoil-like profile geometry makes a low-turbulence, or in a best-case scenario even a turbulence-free, inflow of ambient air into the interior space of the fume cupboard when the front sash 30 is partially or completely open.

Using the hollow profiles 10, 20, so-called support jet streams, meaning pressurised-air jet streams 100, 200 made up of pressurised air, are introduced into the interior space of the fume cupboard along the side walls 36 and the base plate 34. These pressurised-air jet streams are conventionally generated by a fan 70 (FIG. 3) arranged under the worktop 34 and within the housing 60. Although in FIG. 2, the exact arrangement of the hollow profiles 10, 20 can hardly be recognised, the hollow profiles 10, 20 are preferably located in front of the level of the front-most front sash element. The pressurised-air jet streams 100, 200 therefore preferably only reach the interior space of the fume cupboard when the front sash is partially or fully open 30.

The fume cupboard 1 shown in FIG. 1 is purely seen as an example, because the invention can be applied to various types of fume cupboards, for example tabletop fume cupboards, low-space tabletop fume cupboards, low-mounted fume cupboards, walk-accessible fume cupboards or even mobile fume cupboards. On the application day of the present patent application, the fume cupboards also fulfil the European series of standards DIN EN 14175.

Furthermore, the fume cupboards also fulfil other standards, such as ASHRAE 110/1995, which is valid for the United States.

Should reference be made to a standard in this description and the patent claims, the currently valid standard is hereby intended. This is because the regulations specified in the standards are usually always empirically stricter and thus, a fume cupboard, which meets the current standard, also meets the regulations of an older standard.

FIG. 2 shows the course of flow of the pressurised-air jet streams 100, 200 coming out of the hollow profiles 10, 20 within the interior space of the fume cupboard and the exhaust in the duct 63 between the deflection wall 40 in the back wall 62 to the exhaust-air collection duct 50 and an extremely simplified manner. The view in FIG. 2 corresponds to a cross-sectional view along Line A-A in FIG. 1.

As can be recognised in FIG. 2, the deflection wall 40 is preferably spaced away from the base of the worktop 34 and preferably spaced away from the back wall 62 of the housing, whereby the exhaust duct 63 is formed. The deflection wall 40 preferably has a plurality of longitudinal openings 42 (FIG. 1), through which the exhaust and the air flows through, which is located in the interior space of the fume cupboard and, under certain circumstances, is toxic and can enter into the duct 63. At the top 48 within the interior space of the fume cupboard, other openings 47 are preferably provided, through which the light gases and vapours, in particular, can be led to the exhaust-air collection duct 50.

Although not shown in FIG. 1 and FIG. 2, the deflection wall 40 can preferably also be spaced away from the sidewalls 36 of the fume cupboard housing 60. Through a gap designed in this manner, exhaust air can additionally be introduced through this into the exhaust duct 63.

On the deflection wall 40, preferably a plurality of column retainers 44 are provided, into which bars can be clamped in a detachable manner, which serve as holders for test setups within the interior space of the fume cupboard.

As shown in FIG. 3, in the case of the conventional fume cupboard shown in FIG. 1 and FIG. 2, the pressurised air or support jet streams 100, 200 are generated by a fan 70 arranged under the base plate 34 and preferably within the housing 60. The fan 70 used for the measurements carried out within the scope of the invention was a one-side aspirating radial fan made by the company ebm Papst with the name designation, G1G097-AA05-01.

The pressurised air produced by the fan 70 is first fed into the hollow profile 20 arranged in the area of the front side of the base plate 34. The supply of the fan pressurised air into the hollow profile 20 preferably takes place at a point, which is approximately in the middle of the longitudinal path of the hollow profile 20 extending across the width of the fume cupboard. In this way, it is achieved that the pressure drop within the hollow profile 20 is approximately symmetrical in relation to this point.

In FIG. 3, the can also be recognised that the hollow profiles 10, 20 are fluidly connected to each other. By means of this, part of the pressurised air reaches both side post profiles 10 and escapes from the side post profiles 10 in the form of support jet streams 100 along the sidewalls 36 into the interior space of the fume cupboard.

Although one would initially expect the energy demand of the fan 70 to worsen rather than improve the overall energy balance of fume cupboard, in the case of the conventional fume cupboard, Secuflow®, of the applicant, the exhaust volume flow required at least to maintain the standardised outbreak safety due to the positive effect of the support jet streams 100, 200, meaning the minimum volume flow which still fulfils the statutory requirements for outbreak safety of the fume cupboard and which the building-installed exhaust system connected to the exhaust-air collection duct 50 must be able to be generated, could be reduced. By means of this, the energy requirements of the fume cupboard can be reduced to an extent that exceeds the energy requirement the fan, which, in turn, has a positive effect on the overall energy balance of the fume cupboard.

In FIG. 4, the construction and the geometry of a hollow profile 10, 20 designed according to an embodiment of the invention in a cross-section, meaning perpendicular to the longitudinal path of the hollow profile 10, 20 is shown. The outer flow side 10a, 20a is designed as an airfoil in an aerodynamically optimised manner. In the interior space of the hollow profile 10, 20, there is a pressure chamber 10b, 20b. The pressurised air generated by the fan 70 flows through the pressure chamber 10b, 20b along the longitudinal path of the hollow profile 10, 20. Preferably, a plurality of outlet openings 10d, 20d, are also located along the longitudinal path of the hollow profile 10, 20, through which the pressurised air can escape into the interior space of the fume cupboard.

The plurality of spatially separated outlet openings 10d, 20d are arranged within the hollow profile 10, 20 according to the respective use of the fume cupboard 1. They can be irregularly distributed across the length of the hollow profile 10, 20 or arranged according to a certain pattern or even be equidistant or periodically arranged.

The hollow profiles 10, 20 can preferably be made of a single piece along with the respective sidewall 36 and/or the base plate 34, for example, as an extruded aluminium profile. It is also conceivable to place and to attach the hollow profiles 10, 20 to the front side of the respective sidewall 36 and/or the base plate 34, or attach it to this in another way.

The plurality of outlet openings 10d, 20d—with or without an outlet duct 10c, 20c—can be introduced in the form of a profile bar into the respective hollow profile 10, 20 or be made as a single piece along with it.

The geometry shown in FIG. 4 can also be applied to the side post hollow profiles 10 as well as the hollow profile 20 arranged on the front side of the worktop or base plate 34. For better distinctness, in this description and in the patent claims in part, the side post profile is referred to as a first hollow profile 10 and the base plate profile is referred to as a second hollow profile 20.

In order to be able to compare various ducts flown through with a fluid with various cross-sectional shapes with each other in a fluid dynamic manner, the so-called hydraulic diameter is taken into consideration. The term “hydraulic diameter” is well known to the person skilled in the art working in this field and represents a mathematical factor, which indicates the diameter of a flow duct with any cross-section, which has the same pressure loss as a flow pipe with a circular cross-section and the same diameter at the same length and same average flow speed.

In the case of the conventional fume cupboard, Secuflow®, of the applicant, the longitudinal measurement of the outlet openings 10d, 20d, meaning the path of the outlet openings 10d, 20d in a longitudinal direction of the hollow profiles 10, 20 is equal to 30 mm and the lateral measurement perpendicular to this is equal to 2 mm. In the case of a rectangular outlet opening, the hydraulic diameter is calculated according to the formula dₕ=2ab/(a+b). If a=30 mm and b=2 mm, the hydraulic diameter of each outlet opening 10d, 20d in the case of the conventional fume cupboard, Secuflow®, is equal to 3.75 mm and the surface area is 60 mm².

In the case of the hollow profiles 10, 20 shown in FIG. 4 according to a preferred embodiment of the invention, the surface area of the outlet openings 10d, 20d are in turn preferably only 1 mm² to 4 mm², and even more preferably 1.8 mm² to 3 mm². Thereby the outlet openings 10d, 20d can preferably have a circular, round, oval, rectangular or polygonal shape.

The longitudinal path of the almost rectangular outlet openings 10d, 20d is preferably 3 mm and the lateral measurement perpendicular to this is preferably 1 mm. This results in a hydraulic diameter of 1.5 mm. A hollow profile 10, 20 with outlet openings 10d, 20d designed in this manner was also used in the case of a series of measurements carried out within the scope of the invention. In the following, this hollow profile 10, 20 is also referred to with the term “Jet nozzles”.

According to another aspect of the invention, at least one outlet opening 10d, 20d is fluidically connected to the pressure chamber 10b, 20b (FIG. 4) via a duct 10c, 20c, that has a length L, preferably all of the outlet openings 10d, 20d provided in the hollow chamber 10, 20 are connected in this manner.

In the case of the hollow profile 10a, 20b shown in FIG. 4, length L of the duct is preferably 9 mm. The ratio of the length L to the hydraulic diameter (1.5 mm) is therefore equal to 6.

The series of measurements carried out within the scope of the invention lead to the conclusion that the duct 10c, 20c, which is fluidically connected to preferably one outlet opening 10d, 20d respectively. should have a length L, which is at least three times, preferably four times to eleven times the hydraulic diameter of the outlet opening 10d, 20d. Only in the case of a duct length L, which fulfils this requirement are pressurised air jet streams emitted into the interior space of the fume cupboard, that are “provided” with the direction that is considerably more pronounced than in the case of air jet streams that must run through a shorter duct. By means of this, the opening angle of the pressurised-air jet streams 100, 200 dispersed within the interior space of the fume cupboard are reduced. In other words, the pressurised-air jet streams 100, 200 are already so strongly oriented at the point in time that the escape from the outlet openings 10d, 20d that they come into incredibly close contact with the sidewalls 36 and the base plate 34.

In contrast to this, the extruded aluminium hollow profile 10, 20 used in the case of the conventional fume cupboard, Secuflow®, had a thickness of 2 mm, meaning, the duct in front of the outlet opening had a length L of only 2 mm. The ratio of the length L to the hydraulic diameter (3.75 mm) was therefore considerably smaller than 1.

The angle α (FIG. 4) the duct 10c, 20c forms relative to the sidewall 36 and/or to the base plate 34, which preferably extends in a straight manner, is preferably at a range of 0° to 10°. At this point, it should be mentioned that a jet air stream, which runs through a duct at an angle of 0° to the corresponding side wall or the base plate, is not spread out absolutely parallel to the side wall or to the base plate inside the fume cupboard. This is due to the circumstance that the average velocity vector itself always forms an angle greater than 0° to the side wall 36 or to the base plate 34 with a parallel supply of blowing air.

According to another preferred embodiment of the invention, instead of a straight duct 10c, 20c (FIG. 4) running from the pressure chamber 10b, 20b to the outlet opening 10d, 20d, an outlet geometry shown in FIG. 5 is made available, which makes the blowing out of a preferably periodically oscillating pressurised-air jet stream possible. This nozzle geometry is referred to in the following as Oscijet.

In this context, it is pointed out that the section shown in FIG. 5 corresponds approximately to the partial section shown in FIG. 4 with the dashed line so that the remaining features of the hollow profiles 10, 20, which have been explained in association with FIG. 4, can also be transferred to the hollow profile 10′, 20′ shown in FIG. 5.

The periodic oscillation is preferably generated by auto-stimulation and preferably with the aid of non-movable components, which are preferably made as a single piece along with the hollow profile 10′, 20′. For this purpose, measurements within the scope of the invention were carried out using so-called fluidic oscillators.

Fluidic oscillators are characterized in that they generate an auto-stimulated vibration within the fluid flowing through them. The vibration results from splitting up the fluid flow into a main flow in a sub-flow. While the main flow flows through a main duct 10c′, 20c′, the sub-flow flows through one of the two auxiliary ducts 10f, 20f (FIG. 5) in an alternating manner. In the area of the outlet opening 10d′, 20d′, the sub-flow meets up with the main flow again and deflects it downwards and upwards in an alternating manner, depending on which auxiliary duct 10f, 20f the sub-flow had flown through beforehand. Due to the changing and alternating pressure conditions in the auxiliary ducts, 10f, 20f, the sub-flow flows through the respective other auxiliary duct 10f, 20f in the next cycle. From this, a deflection of the main and sub-flow uniting in the area of the outlet opening 10d′, 20d′ follows in the respective other direction. Then, the cycles are repeated.

Also in the case of the nozzle geometry in FIG. 5, the outlet opening 10d′, 20d′ is fluidically connected to a pressure chamber 10b′, 20b via a duct 10c′, 20c (here, the main duct), which has a length L. Even here, the duct length L is at least three times, preferably four times to eleven times the hydraulic diameter of the outlet opening 10d′, 20d′. In the case of preferred embodiment of the invention, the longitudinal path of the primarily rectangular outlet opening 10d′, 20d′ is equal to 1.8 mm and the path perpendicular to this is equal to 1 mm. This results in a hydraulic diameter of 1.3 mm. The duct length L is preferably 14 mm and therefore approximately 11 times the hydraulic diameter.

As an alternative to the OsciJet nozzle geometry, geometries are also conceivable, which produce a non-periodic pressurised-air jet stream. In other words, such geometries create a pressurised-air jet stream that sweeps back and forth, thereby moving stochastically. For generating such non-periodic pressurised-air jet streams feedback-free fluidic components can be used, being different to the case of fluidic oscillators.

FIG. 6 shows the results of PIV measurements of the flow field of wall jet streams emitted from the side post profile 10 under the use of the conventional nozzle geometry of the Secuflow® fume cupboard (FIG. 6A), the Jet nozzle geometry (FIG. 6B) and the OsciJet nozzle geometry (FIG. 6C). The fan voltage was 9.85V in the case of the measurements shown in FIG. 6.

In FIG. 6a it is clearly visible how the ambient air flowing in through the open front sash goes away from the side wall despite the support jet streams 100 blowing out of the hollow profile 10 approx. 150 mm behind the front sash level, which corresponds to the 0 position. The displacement was not observed by means of missed in the case of previous experiments. Such a displacement cannot be recognised in FIG. 6b and FIG. 6c. In FIG. 6B and FIG. 6C, the ambient air flows along the side wall, without resulting in turbulences or forming backflow areas. Also, the field line density, which indicates higher air speeds is significantly higher than in FIG. 6A in the area of the side wall in FIG. 6B and FIG. 6C. This suggests, that the ambient air in the case of the Jet nozzle geometry (FIG. 6B) and the OsciJet nozzle geometry (FIG. 6C) flows considerably faster toward the deflection wall of the interior space of the fume cupboard, as in the case of the conventional nozzle geometry of the Secuflow® fume cupboard (FIG. 6A). It can also be recognised in FIG. 6B and FIG. 6C how the ambient air itself runs at a distance from the side post profile 10, 10′ (y-axis) in a vortex-like manner toward the side wall, while, in FIG. 6A, the ambient air has the tendency to rather flow away from the side wall.

The PIV measurements of flow field show very clearly that, in the case of the let nozzle (FIG. 4) as also in the OsciJet nozzle (FIG. 5), flow displacements can be effectively prevented. In addition, the incoming ambient air in the front airfoil-shaped area of the side posts comes into better contact, whereby the risk of backflows is further reduced.

A series of PIV measures were carried at out various control voltages of the fan 70 (FIG. 3). Hereby, a higher control voltage corresponds to a higher exhaust speed of the support jet streams. The PIV measurements make it clear that the goal of avoiding flow displacements is achieved even better in the case of higher jet-stream speeds. In order to implement this aspect of the invention, it suffices if a flow displacement is avoided at up to at least 25% of the depth of the workspace in an area of the front side of the workspace. This corresponds to the area of the workspace which must be evaluated in an especially critical manner with reference to dangerous backflow areas. Preferably, this value is at least 50%, and even more preferred 75%.

After the respective control voltage of the fan 70 is experimentally determined, by which an almost turbulence-free course of flow without significant backflow areas could be determined, the inventors have dedicated themselves to the question of which minimum volume flow would be necessary to be able to reproduce a turbulence-free flow field.

Due to the low measurements of the jet and OsciJet nozzle outlet openings 10d, 20d and 10d′, 20d′, a measurement of the air outlet speed provides no reproducible results with the help of a hot-wire anemometer. In the case of OsciJet nozzles, the hot-wire anemometer even vibrates along with the periodically oscillating support jet streams.

According to a further aspect of the invention, a method to determine the minimum volume lows has then been developed. The associated test set-up is shown in FIGS. 7 and 8.

The determination of the volume flow of the wall jet streams takes place in two steps. As is shown in FIG. 7, by using a voltage regulator 72, the control voltage of the fan 70 is set to a value, at which the flow field of the wall jet streams verified by PIV measurements show almost no significant flow displacements. At the measurement points 1, 2, 3, 4, 5 and 6, the static pressure within the hollow profiles 10, 10′ and 20, 20′ are subsequently determined. For this purpose, a pressure transducer 80 is used, which preferably, via the respective pressure transducer lines 82, measures the static pressure in the pressure chambers 10a 10a′ and 20a, 20a′ of the hollow profiles 10, 10′ and 20, 20′. Thereby, the pressure transducer lines 82 are preferably arranged in such a way that there pressure chamber and ends flush with the surface at an inner surface of the respective pressure chambers 10a, 10a′ and 20a, 20a′. In this first measurement step, merely as an example, a hollow profile 10 is used with Jet nozzles on the left side post and a hollow profile 10′ with OsciJet nozzles is used on the right side post.

In a second measurement step, as can be seen in FIG. 8, the fan 70 is replaced by a pressurised-air supply 74. A calibrated pressure regulator or mass flow controller 76 is arranged downstream to the pressurised-air supply 74 The mass flow controller used here was made by Teledyne Hastings instruments, Series 201. After setting the first static reference air pressure determined during the first measurement step in the hollow profiles 10, 10′ and 20, 20′, with the aid of the mass flow controller, the related mass flow can be determined. Taking the ambient pressure and the ambient temperature into account, the volume flow can be calculated from the respective mass flow.

In FIG. 9, the measured static air pressures in the pressure chambers 10a, 10a′ of hollow profiles 10, 10′ are shown. The lowest solid line is merely indicated for comparative purposes and shows the static air pressure in the hollow profile of the serial fume cupboard, Secuflow®′ and that at a fan voltage of 4.41V. the average static air pressure here is 12.5 Pa. The dotted line indicates an average value of 65 Pa and was determined for the Jet—and OsciJet nozzles at a 4.41-V fan voltage. The top dashed line corresponds to an average air pressure of 197 Pa. This was determined in the case of a fan voltage of 9.85 bolts under the use of Jet and OsciJet nozzles. Here, it is pointed out that, in FIG. 9, the average static air pressures measured within the serial profile of the Secuflow® fume cupboard at a fan voltage of 9.85V are not shown.

The resulting volume flows are listed in FIG. 10. With the optimised wall jet-stream nozzles, Jet and OsciJet, the required minimum volume flow is reduced with regard to the serial fume cupboard, Secuflow®, by 68% in the Jet design and by 76% in the OsciJet design.

In accordance with another aspect of the invention, the inventors have concluded that, due to the reduced volume flows, it is now possible to operate a full-fledged fume cupboard with a commonly available pressurised-air system installed in a building according to regulations, meaning a fume cupboard that meets the requirements of the series of standards DIN EN 14175. Here, it is known to the person skilled in the art that such pressurised-air system installed in buildings can commonly make air pressure available at range of 0 to 7 bar. A powered fan is therefore spared.

Not all outlet openings 10d, 10d′ of the side post profile 10, 10′ and not all outlet openings 20d, 20d′ of the base-plate profile 20, 20′, which are intended for emitting wall jet streams 100 or base jet streams 200 into the respected hollow profile 10, 20, must have the nozzle geometry shown in FIG. 4 or FIG. 5 according to the invention in order to implement the object indicated in the patent claims. Therefore, it is sufficient that at least an outlet opening 10d, 10d′ of the side post profile 10, 10′ or at least an outlet opening 20d, 20d′ of the base-plate profile 20, 20′ is/are designed in such a way. The same applies to the length L of the duct 10c, 10c′ and 20c, 20c′, which is provided directly upstream to the respective outlet opening 10d, 10d′ and 20d, 20d′

1-20. (canceled)

21. A fume cupboard for a laboratory space, the fume cupboard comprising a housing in which a work space is located, which is limited on the front side by a front sash, on the base by a base plate and on the side by a side wall respectively and a first hollow profile arranged on a front side of each side wall, wherein each hollow profile has a first pressure chamber, which is fluidically connected to a plurality of first openings, out of which air jet streams in the form of wall jet streams consisting of pressurised air can be emitted along the respective side wall into the work space, wherein at least one of the first openings is fluidically connected to the first pressure chamber via a first longitudinal duct, and that the first duct has a length L in the direction of flow that is at least three times the hydraulic diameter of a cross-sectional surface of the first opening, from the perspective perpendicular to the direction of flow, in order to prevent flow displacement of the wall jet stream coming out of the first opening of the side wall in an area of the front side of the work space up to at least 25% of the depth of the work space.

22. A fume cupboard according to claim 21 having a second hollow profile arranged on a front side of the base plate, wherein the second hollow profile has a second pressure chamber, which is fluidically connected to a plurality of second openings, out of which air jet streams in the form of base jet streams consisting of pressurised air can be emitted along the respective base plate into the work space, wherein at least one of the second openings is fluidically connected to the second pressure chamber via a second longitudinal duct, and that the second duct has a length L in the direction of flow that is at least three times the hydraulic diameter of a cross-sectional surface of the second opening, from the perspective perpendicular to the direction of flow, in order to prevent flow displacement of the base jet stream coming out of the second opening of the base plate in an area of the front side of the work space up to at least 25% of the depth of the work space.

23. A fume cupboard according to claim 21, wherein the first and/or the second duct has a length L in the direction of flow, which is at a range of four times to eleven times the hydraulic diameter of the cross-sectional area of the first and/or the second opening.

24. A fume cupboard according to claim 21, wherein no flow displacement of the wall jet stream coming out of the first opening from the side wall and/or of the base jet stream coming out of the second opening from the base plate occurs in an area of the front side of the work space up to at least 50% of the depth of the work space.

25. A fume cupboard according to claim 21, wherein no flow displacement of the wall jet stream coming out of the first opening from the side wall and/or of the base jet stream coming out of the second opening from the base plate occurs in an area of the front side of the work space up to at least 75% of the depth of the work space.

26. A fume cupboard according to claim 21, further comprising a first and/or a second pressure transducer which is/are fluidically connected to the first and/or the second pressure chamber.

27. A fume cupboard according to claim 26, wherein the first and/or the second pressure transducer comprises a first and/or a second pressure transducer line, which is arranged in such a way that a pressure-chamber end of the first and/or second pressure transducer line ends in being flush with an inner surface of the first and/or the second pressure chamber.

28. A fume cupboard according to claim 21, further comprising a control device which adjusts the pressure in the first and/or the second pressure chamber at a range from 50 Pa 500 Pa during intended uses of the fume cupboard.

29. A fume cupboard according to claim 28, further comprising a first and/or a second pressure transducer which is/are fluidically connected to the first and/or the second pressure chamber, the control device being electrically connected to the first and/or second pressure transducer.

30. A fume cupboard according to claim 28, wherein the control device is a pressure reducer or a mass flow controller that is arranged upstream to the first and/or the second pressure chamber.

31. A fume cupboard according to claim 30, wherein the pressure reducer or mass flow regulator is arranged within the housing.

32. A fume cupboard according to claim 21, wherein a cross-sectional surface at least of a first and/or a second opening, viewed perpendicular to the direction of flow, is at a range of 1 mm² to 4 mm².

33. A fume cupboard according to claim 21, wherein a cross-sectional surface, viewed perpendicular to the direction of flow, at least of a first and/or a second opening, is at a range of 1.8 mm² to 3 mm².

34. A fume cupboard according to claim 21, wherein at least a first or a second opening are/is designed in such a way that the pressurised-air jet stream coming out of the first and/or the second opening is emitted into the work space as a periodically oscillating wall jet stream and/or as a periodically oscillating base jet stream.

35. A fume cupboard according to claim 34 characterized in that the periodicity is at a range of 1 Hz to 100 KHz.

36. A fume cupboard according to claim 34 wherein the periodic oscillation of the wall jet stream and/or the periodic oscillation of the base jet stream is generated by merely non-moving components of the first and/or the second hollow profile.

37. A fume cupboard according to claim 34 wherein the periodic oscillation of the wall jet stream and/or the periodic oscillation of the base jet stream is generated by auto-stimulation.

38. A fume cupboard according to claim 34, further comprising a first and/or a second fluidic oscillator which comprise/comprises the first and/or the second opening and which generates/generate the periodic oscillation of the wall jet stream/wall jet streams and/or the periodic oscillation of the base jet stream/base jet streams.

39. A fume cupboard according to claim 21, wherein the first and/or the second openings have a circular, round, oval, rectangular or polygonal shape.

40. A fume cupboard for a laboratory space, the fume cupboard comprising a housing in which a work space is located, which is limited on the front side by a front sash, on the base by a base plate and on the side by a side wall respectively and a second hollow profile arranged on a front side of the base plate, wherein the second hollow profile has a second pressure chamber, which is fluidically connected to a plurality of second openings, out of which air jet streams in the form of base jet streams consisting of pressurised air can be emitted along the respective base plate into the work space, wherein at least one of the second openings is fluidically connected to the second pressure chamber via a second longitudinal duct, and that the second duct has a length L in the direction of flow that is at least three times the hydraulic diameter of a cross-sectional surface of the second opening, from the perspective perpendicular to the direction of flow, in order to prevent flow displacement of the base jet stream coming out of the second opening of the base plate in an area of the front side of the work space up to at least 25% of the depth of the work space.
